(19) United States
(12) Patent Application Publication
(10) Pub. No.: US 2019/0202996 A1
(43) Pub. Date: Jul. 4, 2019

(54) POLYIMIDE HYBRID MATERIAL, PRECURSOR SOLUTION AND MANUFACTURE METHOD THEREOF

(71) Applicant: INDUSTRIAL TECHNOLOGY RESEARCH INSTITUTE, Hsinchu (TW)

(72) Inventors: Dong-Sen CHEN, Zhudong Township (TW); Yu-Ju KUO, New Taipei City (TW); Chyi-Ming LEU, Jhudong Township (TW)

(73) Assignee: INDUSTRIAL TECHNOLOGY RESEARCH INSTITUTE, Hsinchu (TW)

(21) Appl. No.: 15/858,426

(22) Filed: Dec. 29, 2017

(51) Int. Cl. C08G 83/00; C09D 187/00; C08G 73/10; C09D 179/08

(52) U.S. Cl. CPC C08G 83/001; C09D 187/005; C09D 179/08; C08G 73/1028; C08G 73/1067; C08G 83/003

(57) ABSTRACT

A polyimide precursor solution is provided. The polyimide precursor solution includes 100 parts by weight of a fully aromatic polyamic acid, 5-20 parts by weight of silica particles, 10-40 parts by weight of an alkoxysilane, and 60-80 parts by weight of a solvent.

### TECHNICAL FIELD

The present disclosure relate to polymeric material, and in particular it relates to a polyimide hybrid material, a precursor solution, and a manufacturing method thereof.

### BACKGROUND

Polyimide has flexibility, sufficient mechanical strength, chemical resistance and other characteristics, and thus is widely used in various industries such as the plastics industry, the electronics industry, and the aerospace industry.

As display technologies have developed, transparent displays have acquired such advantages as being thin and transparent, and they can combine information on the panel with entities to provide more information. Due to the rise of transparent displays, the need for flexible substrates used as transparent displays has increased in recent years. Polyimide has flexibility and sufficient mechanical strength and is therefore suitable for use as substrates for flexible transparent displays. However, current polyimide substrate materials still have some properties to be improved in order to meet people's increasingly stringent requirements for the quality of displays.

### SUMMARY

The present disclosure provides a polyimide precursor solution, including 100 parts by weight of a fully aromatic polyamic acid; 5-20 parts by weight of silica particles; 10-40 parts by weight of an alkoxysilane; and 40-80 parts by weight of a solvent.

The present disclosure also provides a polyimide hybrid material, including 20-40 parts by weight of a fully aromatic polyimide; and 5-20 parts by weight of silica particles, wherein the silica particles are connected to each other by a siloxane skeleton and the siloxane skeleton forms a hydrogen bond with the polyimide, and the polyimide hybrid material has a transmittance that is greater than 80% at a wavelength of 550 nm and a yellowing b* less than 3. In another embodiment, the present disclosure provides a polyimide hybrid material, including 80-40 parts by weight of a fully aromatic polyimide; and 20-60 parts by weight of silica particles, wherein the silica particles are connected to each other by a siloxane skeleton and the siloxane skeleton forms a hydrogen bond with the polyimide, and the polyimide hybrid material has a transmittance that is greater than 80% at a wavelength of 550 nm and a yellowing b* less than 3.

The present disclosure further provides a manufacturing method of polyimide hybrid material, including (a) condensation polymerizing at least one aromatic dianhydride monomer and at least one aromatic diamine monomer in a solvent to form a fully aromatic polyamic acid; (b) providing a mixture containing a silica sol and an alkoxysilane; (c) mixing the mixture and the fully aromatic polyamic acid to form a polyimide precursor solution; and (d) performing an imidization to the polyimide precursor solution to form a polyimide hybrid material.

A detailed description is given in the following embodiments with reference to the accompanying drawings.

### BRIEF DESCRIPTION OF THE DRAWINGS

FIG. 1 is a flow chart for manufacturing the polyimide hybrid material of the embodiments of the present disclosure.

FIG. 2 is a schematic structural diagram of the polyimide hybrid material of the embodiments of the present disclosure.

FIG. 3 is a transmission electron micrograph of the polyimide hybrid material of an example.

### DETAILED DESCRIPTION

The polyimide substrate materials that are currently used may undergo yellowing during high-temperature processing. Therefore, there is a need for a polyimide substrate material that can maintain high transparency and low yellowing even after a high-temperature process, to meet the needs of transparent displays.

The present disclosure provides a polyimide hybrid material introduced with a fully aromatic monomer. Also, a particle-miniaturized hybridization and an alkoxysilane are used to undergo a sol-gel reaction to form the dendritic siloxane skeleton between the silica particles. The dendritic siloxane skeleton is able to form hydrogen bonds with the polyimide polymers. In this way, it is possible to produce a polyimide thin film with high transparency and low yellowing under a high-temperature process.

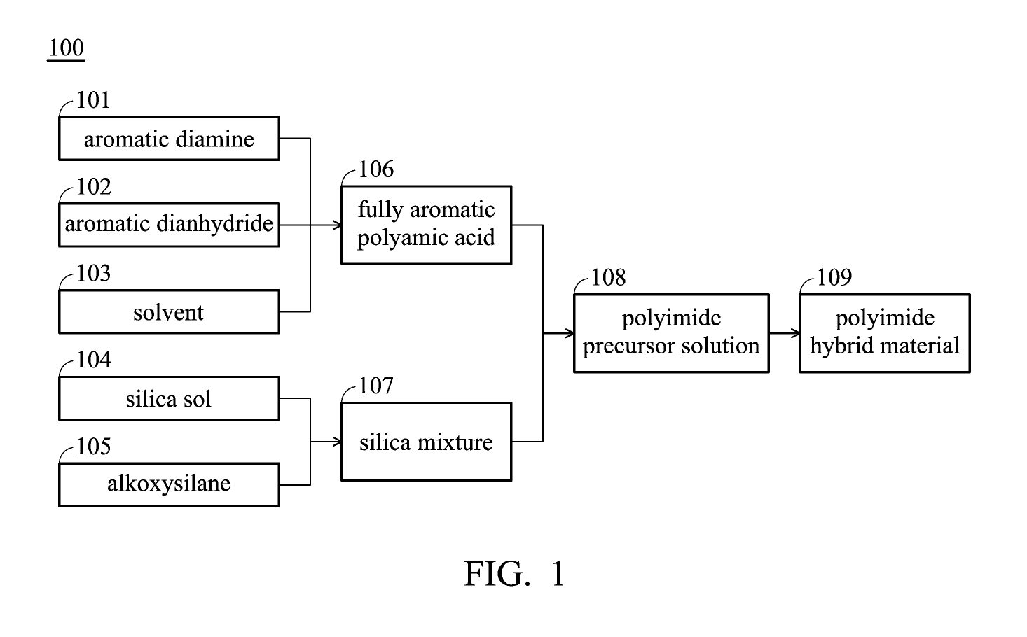

Please refer to the flow chart of FIG. 1, the polyimide hybrid material 109 of the present disclosure is formed by performing an imidization to the polyimide precursor solution 108. The polyimide precursor solution 108 is formed by mixing a fully aromatic polyamic acid 106 and a silica mixture 107. The fully aromatic polyamic acid 106 is formed by condensation polymerizing an aromatic diamine 101, an aromatic dianhydride 102, and a solvent 103. The silica mixture 107 includes a silica sol 104 and an alkoxysilane 105. Hereinafter, the manufacturing method of the polyimide hybrid material will be described in detail.

Since the fully aromatic polyamic acid polymerized by the aromatic diamine and the aromatic dianhydride has aromatic rings with high bond energy, the thermal resistance is good and the resulting polyimide is not easily cracked even at high temperature. However, because of the intramolecular resonance caused by aromatic rings, it is easy to result in the yellowing of polyimides due to charge transfer.

According to the embodiments of the present disclosure, it is preferable that at least one of the aromatic diamine and the aromatic dianhydride has halogen or haloalkyl substituents. The halogen or haloalkyl substituents are electron-withdrawing groups and are therefore capable of reducing the intramolecular resonance of polyimide polymers, and achieve the effect of reducing the yellowing of polyimides.

The aromatic diamine 101 used in the present disclosure may have a structure like the one shown in one of the following formulas, formula (1)˜formula (3). Since having aromatic rings with high bond energy, the aromatic diamine has high thermal resistance.

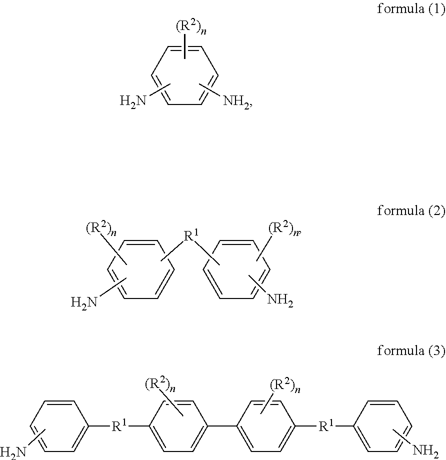

wherein R¹ is a single bond, —O—, —S—, —CH₂—, —S(O)₂—, —C(CF₃)₂—, —C(CH₃)₂—, —O—(CH₂)_{c}—O—, —(O—CH₂—CH₂)_{c}—O—, haloalkyl group, substituted or unsubstituted C₁₋₁₀ linear or branched hydrocarbylene group, substituted or unsubstituted C₆₋₂₀ arylene group,

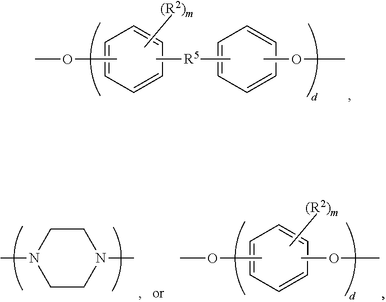

wherein each of c and d is independently an integer between 1 and 20; each of m is independently an integer between 0 and 4;

each of R² is independently hydrogen, halogen, alkyl group, C₁₋₄ alkoxy group, hydroxyl group, C₁₋₄ haloalkyl group, or substituted or unsubstituted C₁₋₆ hydrocarbon group; R⁵ is a single bond, —S(O)₂—, substituted or unsubstituted C₁₋₄ linear or branched hydrocarbylene group, or C₁₋₄ halogenalkylene group; and

each of n is independently an integer between 0 and 4.

It should be noted that, in the present disclosure, one type of aromatic diamine may be used alone, and two or more types of aromatic diamine may also be used in combination. In some embodiments, the aforementioned aromatic diamine has the following structures:

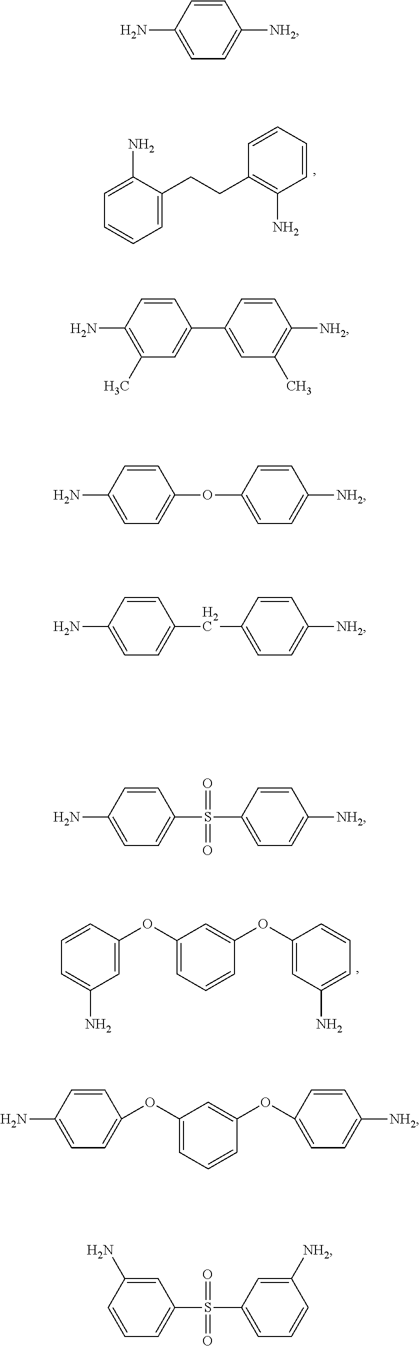

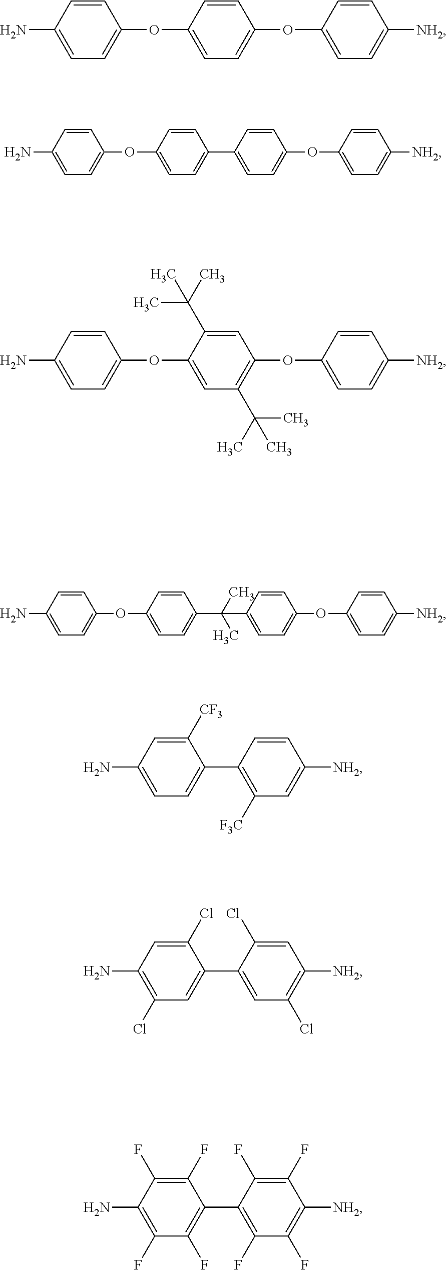

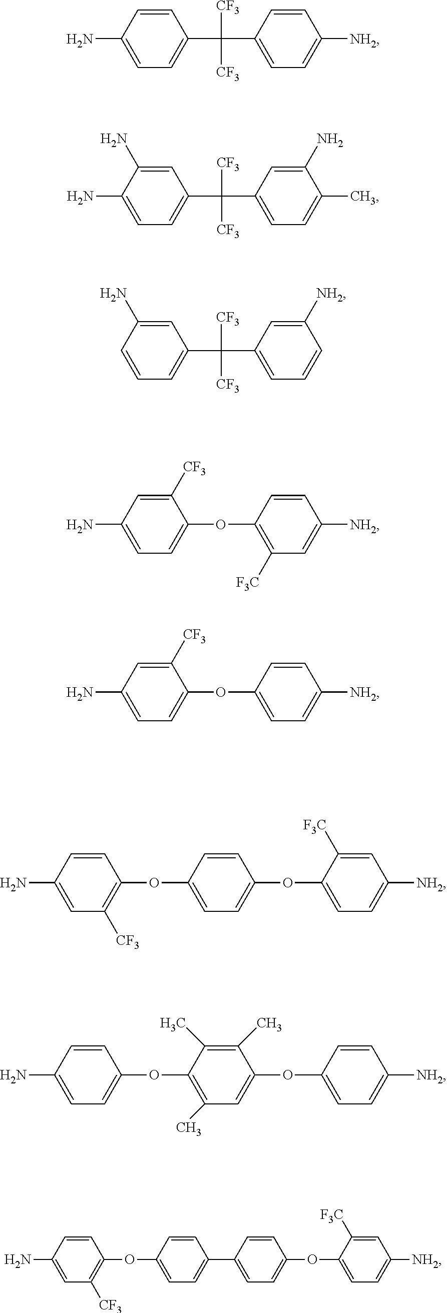

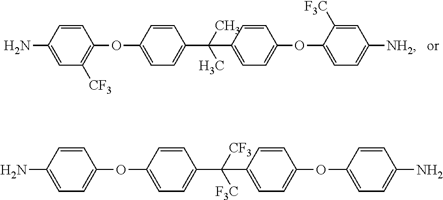 [SMILES: CC(C)(c1ccc(Oc2ccc(N)cc2C(F)(F)F)cc1)c1ccc(Oc2ccc(N)cc2C(F)(F)F)cc1 ; Nc1ccc(Oc2ccc(C(c3ccc(Oc4ccc(N)cc4)cc3)(C(F)(F)F)C(F)(F)F)cc2)cc1]

The following table lists specific examples and corresponding chemical names of some aromatic diamines.

| aromatic diamine | chemical name |
|---|---|
| 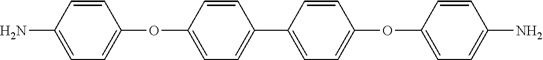 [SMILES: Nc1ccc(Oc2ccc(-c3ccc(Oc4ccc(N)cc4)cc3)cc2)cc1] | 4,4′-bis(4-aminophenoxy) biphenyl (BAPB) |
| 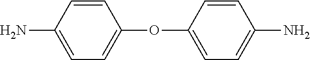 [SMILES: Nc1ccc(Oc2ccc(N)cc2)cc1] | 4,4′-diaminodiphenyl ether (ODA) |
| 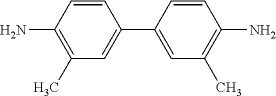 [SMILES: Cc1cc(-c2ccc(N)c(C)c2)ccc1N] | 3,3′-dimethylbiphenyldiamine (DMB) |
| 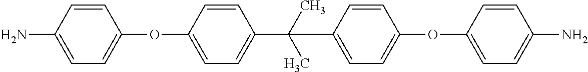 [SMILES: CC(C)(c1ccc(Oc2ccc(N)cc2)cc1)c1ccc(Oc2ccc(N)cc2)cc1] | 2,2-bis[4-(4-aminophenoxy) phenyl]propane (BAPP) |
| 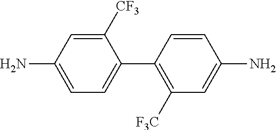 [SMILES: Nc1ccc(-c2ccc(N)cc2C(F)(F)F)c(C(F)(F)F)c1] | 2,2′-bis(trifluoromethyl) benzidine (TFMB) |

The aromatic dianhydride used in the present disclosure may have a structure like the one shown in one of the following formulas, formula (4) or formula (5). Since having aromatic rings with high bond energy, the aromatic dianhydride has high thermal resistance.

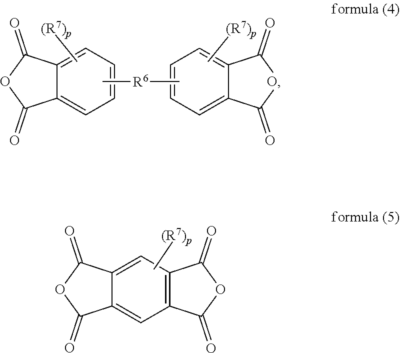

wherein R⁶ is a single bond, —O—, —S—, —S(O)₂—, —C(CF₃)₂—, —C(CH₃)₂-—, —O—(CH₂)_{c}—O—, —(O—CH₂—CH₂),—O—, haloalkyl group, substituted or unsubstituted C₁₋₁₀ linear or branched hydrocarbylene group, substituted or unsubstituted C₆₋₂₀ arylene group,

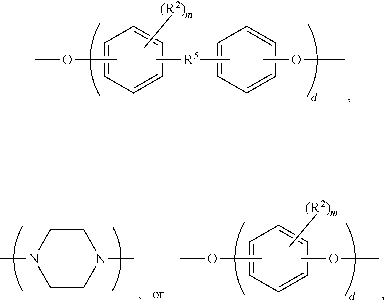

wherein each of c and d is independently an integer between 1 and 20; each of m is independently an integer between 0 and 4; each of R² is independently hydrogen, halogen, alkyl group, C₁₋₄ alkoxy group, hydroxyl group, C₁₋₄ haloalkyl group, or substituted or unsubstituted C₁₋₆ hydrocarbon group; R⁵ is a single bond, —S(O)₂—, substituted or unsubstituted C₁₋₄ linear or branched hydrocarbylene group, or C₁₋₄ halogenalkylene group;
each of R⁷ is independently hydrogen, halogen, alkyl group, C₁₋₄ alkoxy group, hydroxyl group, C₁₋₄ haloalkyl group, or substituted or unsubstituted C₁₋₆ hydrocarbon group; each of p is independently an integer between 0 and 4; and q is an integer between 0 and 2.

It should be noted that, in the present disclosure, one type of aromatic dianhydride may be used alone, and two or more types of aromatic dianhydride may also be used in combination. In some embodiments, the aforementioned aromatic dianhydride has the following structure:

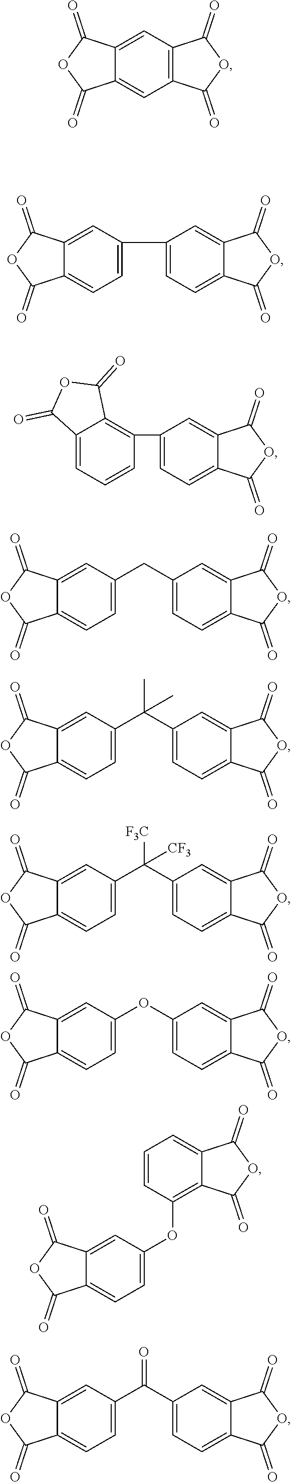

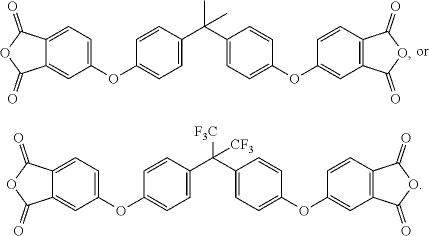 [SMILES: CC(C)(c1ccc(Oc2ccc3c(c2)C(=O)OC3=O)cc1)c1ccc(Oc2ccc3c(c2)C(=O)OC3=O)cc1 ; "or" ; O=C1OC(=O)c2cc(Oc3ccc(C(c4ccc(Oc5ccc6c(c5)C(=O)OC6=O)cc4)(C(F)(F)F)C(F)(F)F)cc3)ccc21]

The following table lists specific examples and corresponding chemical names of some aromatic dianhydrides.

| aromatic dianhydride | chemical name |
|---|---|
| 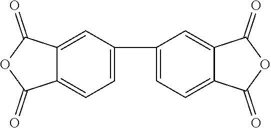 [SMILES: O=C1OC(=O)c2cc(-c3ccc4c(c3)C(=O)OC4=O)ccc21] | 3,3′,4,4′-biphenyltetracarboxylic dianhydride (BPDA) |
| 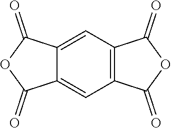 [SMILES: O=c1oc(=O)c2cc3c(=O)oc(=O)c3cc12] | pyromellitic dianhydride (PMDA) |
| 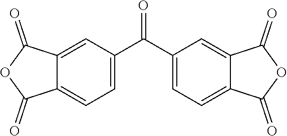 [SMILES: O=C(c1ccc2c(c1)C(=O)OC2=O)c1ccc2c(c1)C(=O)OC2=O] | 3,3′4,4′-benzophenonetetracarboxylic dianhydride (BTDA) |
| 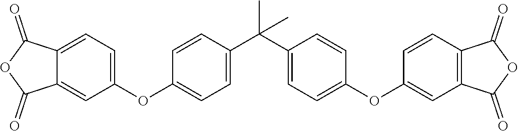 [SMILES: CC(C)(c1ccc(Oc2ccc3c(c2)C(=O)OC3=O)cc1)c1ccc(Oc2ccc3c(c2)C(=O)OC3=O)cc1] | 4,4-bisphenol A dianhydride (BPADA) |
| 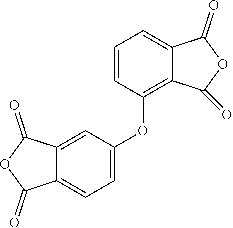 [SMILES: O=C1OC(=O)c2cc(Oc3cccc4c3C(=O)OC4=O)ccc21] | diphenylether tetracarboxylic dianhydride (ODPA) |
| 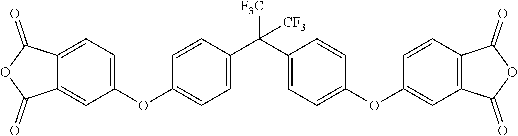 [SMILES: O=C1OC(=O)c2cc(Oc3ccc(C(c4ccc(Oc5ccc6c(c5)C(=O)OC6=O)cc4)(C(F)(F)F)C(F)(F)F)cc3)ccc21] | 2,2-bis[4-(3,4- dicarboxyphenoxy)phenyl] hexafluoroisopropane dianhydride |
| 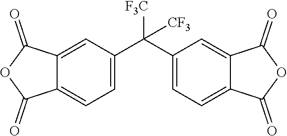 [SMILES: O=C1OC(=O)c2cc(C(c3ccc4c(c3)C(=O)OC4=O)(C(F)(F)F)C(F)(F)F)ccc21] | 4,4′-(hexafluoroisopropylidene) diphthalic anhydride (6FDA) |

The solvent 103 used in the present disclosure may include, for example, N,N-dimethylformamide (DMF), N,N-diethylformamide, N,N-dimethylacetamide (DMAc), N,N-diethylacetamide, N-methylpyrrolidone (NMP), N-ethylpyrrolidone (NEP), dimethylsulfoxide (DMSO), diethyl sulfoxide, γ-butyrolactone (GBL), xylene, tetrahydrofuran, or a combination thereof.

The manufacturing method of the fully aromatic polyamic acid 106 is to dissolve an appropriate amount of aromatic diamine 101 in the solvent 103 first and the aromatic dianhydride 102 is added thereafter, and then it is heated to undergo a condensation polymerization. The condensation polymerization may last for 4-12 hours at 180-230° C., for example, reacting at 210° C. for 4 hours. After the reaction is completed, it is cooled down to obtain the fully aromatic polyamic acid 106.

The molar ratio of the added aromatic diamine and the aromatic dianhydride may be properly selected according to the needs, and it is usually 1:1.15-1:1.05. If the amount of aromatic diamine is too high or the amount of aromatic dianhydride is too high, the resulting polyamic acid is easily hydrolyzed and difficult to be preserved. The weight average molecular weight of the fully aromatic polyamic acid of the present disclosure may be 100,000-500,000, for example, may be 150,000-350,000.

The manufacturing method of the present disclosure further includes mixing the silica sol 104 and the alkoxysilane 105 to form the silica-containing mixture 107. The silica mixture 107 will be subsequently used to form the siloxane skeleton.

The aforementioned silica sol 104 is formed by uniformly dispersing silica particles in a solvent. Because the particles are small enough, they do not settle due to gravity. Also, no gelation would occur and the silica particles do not aggregate into blocks. The silica particles contained in the silica sol have a particle size ranging from 0.5 nm to 20 nm, or 5 nm to 50 nm, for example, 10 nm to 30 nm. The solvent may be aqueous or may be organic solvents, for example, water, alcohols, and so on. The concentration of the silica particles in the silica sol is usually between 25-50 wt %. Appropriate concentration may be selected according to the needs.

The silica sol may be manufactured by the following method. The alkali metal silicate solution is neutralized to form silicon dioxide cores in the solution. The size of the silicon dioxide core may be changed by adjusting the pH value of the solution. If the pH value is lower than 7 or an acid is added, the silicon dioxides form larger particles and are unstable in the solution. If the solution continues to have a weak base, silicon dioxides remain separated and begin to grow into silicon dioxide particles. After the required particle size is obtained, the pH value of the solution can be adjusted so that the silica dioxide particles are stably suspended in the solvent. The pH value is usually between pH 8-10. Commercial silica sol such as sodium silicate may also be used.

The aforementioned alkoxysilane 105 may have the following structure: Si(OR)₄, wherein R is C₁-C₁₀ hydrocarbon group, which may be C₂-C₆ hydrocarbon group. The hydrocarbon group includes alkyl groups, aromatic groups, aromatic alkyl groups, alkenyl groups, or aromatic alkenyl groups having 1-10 carbon atoms. The specific embodiments of the alkoxysilane 105 includes tetramethoxysilane, tetraethoxysilane, tetraisopropoxysilane, tetrapropoxysilane, tetrabutoxysilane, tetraphenoxysilane, tetra(2-methoxyethoxy)silane, tetra(2-ethylhexyloxy)silane, tetraallyloxysilane, or a combination thereof.

The polyimide precursor solution 108 is formed by mixing the aforementioned fully aromatic polyamic acid 106 and the aforementioned silica mixture 107. It should be noted that the polyimide precursor solution in the embodiments of the present disclosure does not include catalysts for a sol-gel reaction. This part will be described in detail later.

The composition of the polyimide precursor solution of the present disclosure includes 5-20 parts by weight of silica particles, 10-40 parts by weight of an alkoxysilane, and 40-80 parts by weight of a solvent, compared to 100 parts by weight of a fully aromatic polyamic acid. The solid content of the polyimide precursor solution of the present disclosure may be between 10-50 wt %, such as 20-40 wt %.

In some embodiments, the composition of the polyimide precursor solution includes the silica particles between 5-10 parts by weight, 10-15 parts by weight, or 15-20 parts by weight. In other embodiments, the alkoxysilane is between 15-10 parts by weight, 10-5 parts by weight, or 5-0 parts by weight. When the ratio of alkoxysilane in the polyimide precursor solution is lower than 5 parts by weight, the overall silica conversion rate is too low so that the amount of nanoparticles is too small, such that the yellow index cannot be reduced. When the ratio is higher than 40 parts by weight, the nanoparticles will self-aggregate and the haze is increased and the transmittance is decreased.

Various additives may be added to the polyimide precursor solution 108 of the present disclosure as needed, for example, leveling agents, defoaming agents, coupling agents, dehydrating agents, metal adhesion promoters, ring-closure promoters, and so on.

The polyimide hybrid material 109 of the present disclosure is produced after performing an imidization to the aforementioned polyimide precursor solution 108. The method for performing the imidization to the polyamic acid includes thermal imidization. The thermal imidization may be performed at a temperature of 300-500° C. for 4-8 hours, for example, at a temperature of 400° C. for 6 hours.

According to the manufacturing method of the present disclosure, the thermal imidization and the self-assembly are performed simultaneously to form the siloxane skeleton. Generally, when alkoxysilane is used to produce siloxane skeleton by sol-gel reaction, catalysts need to be added to promote the reaction. For example, acid catalysts or base catalysts can be used to adjust the pH value. Examples of acid catalysts include hydrochloric acid, sulfuric acid, and nitric acid. Examples of base catalysts include sodium hydroxide and ammonia. Examples of neutral catalysts include amino-siloxane and amino compound. In the polyimide precursor solution, alkoxysilane forms siloxane skeleton on the silica particles merely by the promotion of the high temperature of thermal imidization without adding catalysts. The self-assembled nano-scaled silica particles are then formed and make the silica particles connect to each other by the dendritic siloxane skeleton.

Moreover, the catalyst of the sol-gel reaction is also responsible for the yellowing of polyimide. The polyimide precursor solution maintains the effect of low yellowing by not containing the catalyst of the sol-gel reaction.

Before performing the thermal imidization, a coating step may be further included to form a substrate or a thin film. The thickness of thin film may be adjusted according to practical needs. For example, the thickness may be 5-40 μm, such as 12-20 μm. Commonly used coating methods may be selected according to need, and may include a dipping coating method, a spin coating method, a roll coating method, a blade coating method, a rod coating method, and so on, for example.

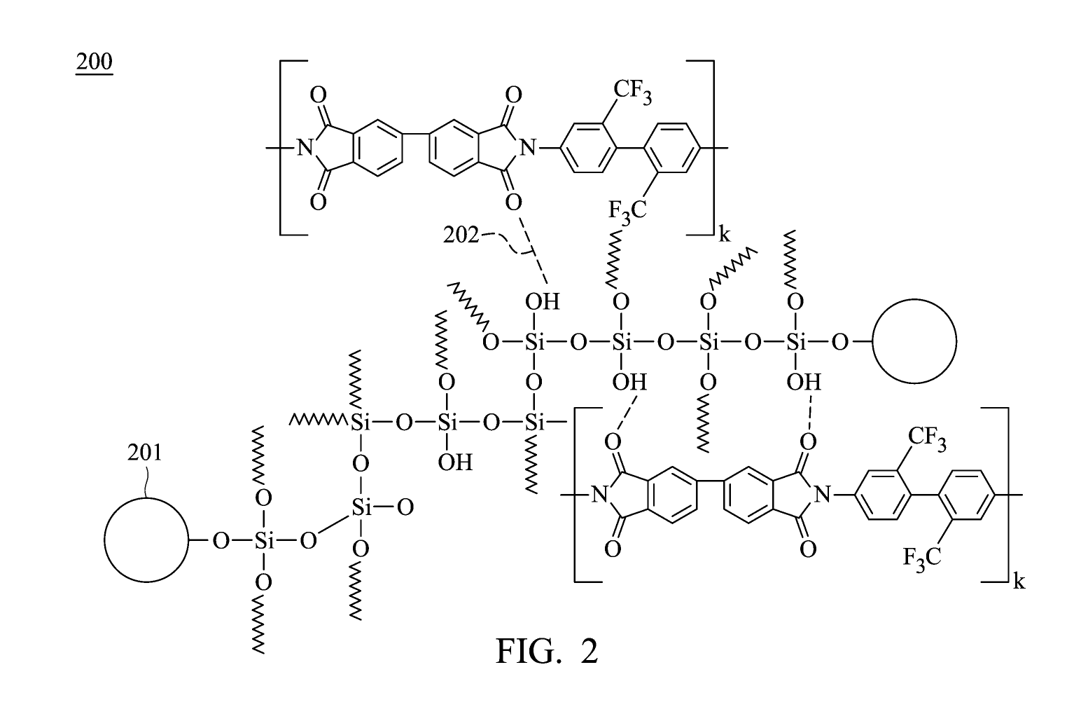

Regarding the polyimide hybrid material 110 in the embodiments of the present disclosure, as shown in the schematic diagram 200 of FIG. 2, by using the miniaturized silica particles 201 and alkoxysilane to form the self-assembled siloxane skeleton, a surface area effect may be increased and therefore the effect of reducing the yellowing of polyimide is achieved. In addition, since hydrogen bonds 202 are formed between the silica particles 201 and the polyimide polymer molecules, the charge transfer between the polyimide polymer molecules may be reduced, thereby reducing the yellowing. In this way, by simultaneously using the miniaturized the silica particles and the alkoxysilane can not only enhance the transmittance of polyimide hybrid material but also reduce the yellowing. In comparison, although the transmittance of polyimide hybrid material which only includes silica particles is enhanced, the yellowing is not reduced. The k in FIG. 2 represents the number of the repeat unit of polyamic acid, which may be an integer between 10 and 600, for example, may be between 100 and 150. In one embodiment, the dendritic branch width of the dendritic structure is 5-30 nm, for example, may be 10-20 nm. It should be noted that the polyimide of FIG. 2 is used as an example of the structure of the fully aromatic polyimide, but the polyimide of the present disclosure is not limited thereto.

According to the embodiments of the present disclosure, the polyimide hybrid material has high transparency. In one embodiment, the thermal resistance of the polyimide thin film is that the polyimide thin is not cracked at 450° C. for 4 hours, a transmittance (%) of greater than 80% at a wavelength of 550 nm, and a yellowing b* less than 3. In the preferred embodiments, the transmittance (%) is greater than 89% and the yellowing b* is less than 2.9.

The polyimide hybrid material in the embodiments of the present disclosure has the characteristics of maintaining high transmittance and low yellowing even after a high-temperature processing, and thus is suitable for use as a flexible substrate for various industries, such as displays, optoelectronics, wearable products, and so on. In addition, although the exemplified polyimide hybrid material may be a thin film, the present disclosure is not limited thereto. The polyimide hybrid material may also be used as coating, fibers, foam plastics, photoresists, alignment agents for liquid-crystal displays, waveguide materials, optical switch materials, and so on.

### Preparation Example 1: Fully Aromatic Polyamic Acid

A three-necked bottle was filled with nitrogen gas at room temperature, and 0.073 mole of ODA and 0.172 mole of TFMB used as diamine were dissolved in 426 g of γ-butyrolactone (gamma-butyrolactone), then 0.250 mole of dianhydride BPADA was added after the two diamines were fully dissolved. After BPADA was fully dissolved, the stirring was kept up for 6 hours to form a viscous polyamic acid solution.

### Preparation Example 2: Mixture Containing Silica Sol and Alkoxysilane

Silica sol was prepared by respectively adding 100 g of acidic aqueous silicon dioxide sol (20 nm, spherical) with 20% solid content, 80 g of isopropanol, and 80 g of DMAc to a 500 ml reactor and distilling water and isopropanol at 25° C.-40° C. by using reduced pressure distillation. Then, a dispersion of silica sol with 20% solid content in DMAc was obtained.

The alkoxysilane was purchased from ACROS (B).

### Example 1: Polyimide Hybrid Material

10 g of 20% silica sol in DMAc (A), 0 g of alkoxysilane (B), and 8 g of polyimide polymer solution (PAA) were put into a 20 g sample vial and stirred at room temperature for 30 minutes, then coated on a glass by blade coating and put into an oven at a temperature of 50° C., 150° C., 210° C., 300° C., and 400° C. for one hour each. The dried coating was removed to obtain the 20% silica/polyimide hybrid thin film.

The resulting polyimide thin film was analyzed by thermal gravimetric analysis (TGA) to obtain the overall silica conversion rate. The results are recited in Table 1.

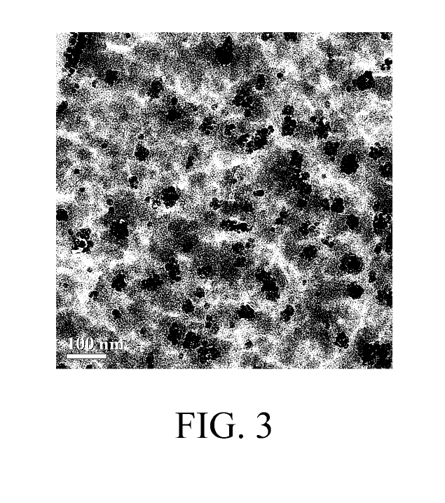

In addition, the resulting polyimide thin film was observed by using a transmission electron microscope, the obtained image was shown in FIG. 3. As can be realized from the result of FIG. 3, the silica particles in the polyimide thin film have a dendritic structure.

### Examples 2-4

The same process as in Example 1 was repeated to prepare the polyimide thin film, except that the precursor solutions of Examples 2-4 were respectively prepared according to the ratio recited in Table 1. The resulting polyimide thin films were analyzed by thermal gravimetric analysis (TGA) to obtain the overall silica conversion rate. The results are recited in Table 1.

TABLE 1

| | polyamic | | | amount | overall conversion |
|---|---|---|---|---|---|
| | acid | silica | TEOS | of silica | rate of |
| | (wt %) | (wt %) | (wt %) | (wt %) | silica (%) |
| Example 1 | 80 | 20 | 0 | 21.1 | ~100 |
| Example 2 | 80 | 15 | 5 | 17.7 | 88.25 |
| Example 3 | 80 | 5 | 15 | 10.3 | 51.3 |
| Example 4 | 80 | 0 | 20 | 3.3 | 16.69 |

It can be realized from the result of Table 1 that the overall silica conversion rate can be increased by adding alkoxysilane to the polyimide precursor solution.

### Examples 5-12 and Comparative Example 1

The same process as in Example 1 was repeated to prepare the polyimide thin film, except that the precursor solutions of Examples 5-12 and Comparative Example 1 were respectively prepared according to the ratio recited in Table 2. The resulting polyimide thin films were respectively measured by a spectrophotometer (SA-400, manufactured by NIPPON DENSHOKU) to obtain the transmittance at a wavelength of 550 nm, yellowing (b*), and yellow index (YI). The results are recited in Table 2.

TABLE 2

| | polyamic | | | transmittance | | | |
|---|---|---|---|---|---|---|---|
| | acid | silica | TEOS | at 550 nm | yellowing | yellowing | thickness |
| | (wt %) | (wt %) | (wt %) | (%) | (b*) | index (YI) | (μm) |
| Comparative | 100 | 0 | 0 | 85.51 | 17.06 | 27.66 | 19-21 |
| Example 1 | | | | | | | |
| Example 5 | 75 | 10 | 15 | 86.81 | 15.62 | 25.19 | 19-21 |
| Example 6 | 70 | 10 | 20 | 86.66 | 15.06 | 24.41 | 19-21 |
| Example 7 | 60 | 10 | 30 | 87.2 | 13.56 | 22.07 | 17-20 |
| Example 8 | 50 | 10 | 40 | 87.2 | 11.52 | 18.8 | 19-21 |
| Example 9 | 80 | 5 | 15 | 86.37 | 16.51 | 26.58 | 19-21 |
| Example 10 | 75 | 5 | 20 | 85.84 | 15.53 | 25.22 | 20-21 |
| Example 11 | 65 | 5 | 30 | 85.03 | 14.06 | 23.11 | 19-21 |
| Example 12 | 55 | 5 | 40 | 85 | 13.06 | 22.32 | 19-21 |

As can be realized from the result of Table 2, compared to Comparative Example 1 in which no silica miniaturized particles and TEOS was added, the polyimide thin films of the present disclosure (Examples 5-12) have higher transmittance at a wavelength of 550 nm (2% enhanced), and the yellowing (b*) and yellow index (YI) thereof are both reduced.

### Examples 13-14 and Comparative Examples 2-4

The same process as in Example 1 was repeated to prepare the polyimide thin film, except that the precursor solutions of Examples 13-14 and Comparative Examples 2-4 were respectively prepared according to the ratio recited in Table 3. The resulting polyimide thin films were cut into a size of 5*5 cm and measured by a spectrophotometer (SA-400, manufactured by NIPPON DENSHOKU) according to the method described in ASTM E308 to obtain the transmittance at a wavelength of 550 nm and the yellowing (b*). The results are recited in Table 3.

TABLE 3

| | polyamic | | | transmittance of | transmittance | | |
|---|---|---|---|---|---|---|---|
| | acid | silica | TEOS | VU-visible light | at 550 nm | yellowing | thickness |
| | (wt %) | (wt %) | (wt %) | at 550 nm (%) | (wt %) | (b*) | (μm) |
| Comparative | 100 | 0 | 0 | 85.324 | 85.91 | 15.71 | 19-21 |
| Example 2 | | | | | | | |
| Comparative | 90 | 10 | 0 | 84.37 | 84.9 | 18.21 | 21-23 |
| Example 3 | | | | | | | |
| Comparative | 80 | 20 | 0 | 85.774 | 86.12 | 15.96 | 21-23 |
| Example 4 | | | | | | | |
| Example 13 | 75 | 20 | 5 | 85.966 | 86.08 | 15.99 | 18-22 |
| Example 14 | 70 | 20 | 10 | 86.533 | 86.68 | 13.73 | 21-23 |

As can be realized from the result of Table 3, compared to Comparative Example 2 which only includes polyamic acid, Comparative Examples 3 and 4 in which silica particles were added have enhanced transmittances; however, the yellowing is not reduced. Moreover, the yellowing is enhanced in Comparative Example 3. In comparison, Examples 13 and 14 in which TEOS were added not only have higher transmittance but also reduced yellowing.

### Examples 15-22 and Comparative Example 5

The same process as in Example 1 was repeated to prepare the polyimide thin film, except that T300B (diamine: ODA, TFMB; dianhydride: BPADA, BPDA; molar ratio was 1:1.05, manufactured by WAKAYAMA) was used as polyamic acid and the precursor solutions of Examples 15-22 and Comparative Example 5 were respectively prepared according to the ratio recited in Table 4. The resulting polyimide thin films were respectively measured by a spectrophotometer (SA-400, manufactured by NIPPON DENSHOKU) to obtain the yellowing (b*) and yellow index (YI). The results are recited in Table 4.

TABLE 4

| | polyamic | | | | | |
|---|---|---|---|---|---|---|
| | acid | silica | TEOS | transmittance | | yellowing |
| | (wt %) | (wt %) | (wt %) | at 550 nm (%) | yellowing (b*) | index (YI) |
| Comparative | 100 | 0 | 0 | 88.39 | 3.4 | 5.82 |
| Example 5 | | | | | | |
| Example 15 | 70 | 30 | 0 | 89.6 | 3.5 | 5.95 |
| Example 16 | 70 | 20 | 10 | 89.58 | 2.94 | 5.01 |
| Example 17 | 70 | 10 | 20 | 89.1 | 3.08 | 5.28 |
| Example 18 | 70 | 0 | 30 | 88.76 | 2.94 | 5.06 |
| Example 19 | 70 | 15 | 15 | 89.05 | 3.55 | 6.08 |
| Example 20 | 70 | 15 | 20 | 89.28 | 3.11 | 5.36 |
| Example 21 | 70 | 15 | 30 | 89.32 | 2.9 | 5.02 |
| Example 22 | 70 | 15 | 40 | 89.35 | 2.78 | 4.8 |

As can be realized from the result of Table 4, in Examples 19-22, when the ratio of the added TEOS is higher, not only the high transmittance can be maintained but also the yellowing and the yellow index can be reduced.

The polyimide thin film formed by the polymide precursor solution of the present disclosure has high transmittance, low yellowing, and low yellow index even after high-temperature processing, and is a flexible substrate suitable for use in various industries.

1. A polyimide precursor solution, comprising:
100 parts by weight of a fully aromatic polyamic acid;
5-20 parts by weight of silica particles;
10-40 parts by weight of an alkoxysilane; and
40-80 parts by weight of a solvent.

2. The polyimide precursor solution as claimed in claim 1, wherein the fully aromatic polyamic acid is polymerized by an aromatic diamine and an aromatic dianhydride, and the molar ratio of the aromatic diamine and the aromatic dianhydride is 1:1.15-1:1.05.

3. The polyimide precursor solution as claimed in claim 2, wherein at least one of the aromatic diamine and the aromatic dianhydride has halogen substituents.

4. The polyimide precursor solution as claimed in claim 1, wherein the particle size of the silica particles is 0.5-20 nm.

5. The polyimide precursor solution as claimed in claim 1, wherein the alkoxysilane comprises tetramethoxysilane, tetraethoxysilane, tetrapropoxysilane, tetrabutoxysilane, or a combination thereof.

6. The polyimide precursor solution as claimed in claim 1, wherein the solvent is selected from N,N-dimethylformamide (DMF), N,N-diethylformamide, N,N-dimethylacetamide (DMAc), N,N-diethylacetamide, N-methylpyrrolidone (NMP), N-ethylpyrrolidone (NEP), dimethylsulfoxide (DMSO), diethyl sulfoxide, γ-butyrolactone (GBL), xylene, tetrahydrofuran, or a combination thereof.

7. The polyimide precursor solution as claimed in claim 1, wherein the polyimide precursor solution does not comprise a catalyst for a sol-gel reaction.

8. A polyimide hybrid material, which is formed by the polyimide precursor solution as claimed in claim 1, comprising:
80-40 parts by weight of a fully aromatic polyimide; and
20-60 parts by weight of silica particles,
wherein the silica particles are connected to each other by a siloxane skeleton and the siloxane skeleton forms a hydrogen bond with the polyimide,
wherein the polyimide hybrid material has a transmittance that is greater than 80% at a wavelength of 550 nm and a yellowing b* less than 3.

9. The polyimide hybrid material as claimed in claim 8, wherein the siloxane skeleton has a dendritic structure.

10. The polyimide hybrid material as claimed in claim 9, wherein the dendritic branch width of the dendritic structure is 5-30 nm.

11. The polyimide hybrid material as claimed in claim 8, wherein the hybrid material is a thin film.

12. The polyimide hybrid material as claimed in claim 11, wherein the thin film has a thickness of 10-40 μm.

13. The polyimide hybrid material as claimed in claim 8, wherein the siloxane skeleton is formed by growing the alkoxysilane on the silica particles.

14. A manufacturing method of polyimide hybrid material, comprising:
(a) condensation polymerizing at least one aromatic dianhydride monomer and at least one aromatic diamine monomer in a solvent to form a fully aromatic polyamic acid;
(b) providing a mixture containing a silica sol and an alkoxysilane;
(c) mixing the mixture and the fully aromatic polyamic acid to form a polyimide precursor solution; and
(d) performing an imidization to the polyimide precursor solution to form a polyimide hybrid material.

15. The manufacturing method of polyimide hybrid material as claimed in claim 14, wherein the imidization is performed at 300° C.-500° C.

16. The manufacturing method of polyimide hybrid material as claimed in claim 14, wherein the silica sol and the alkoxysilane are self-assembled to form the siloxane skeleton during the imidization.

17. The manufacturing method of polyimide hybrid material as claimed in claim 14, further comprising coating the polyimide precursor solution to a substrate before the imidization.
